(19) United States
(12) Patent Application Publication
(10) Pub. No.: US 2022/0245613 A1
(43) Pub. Date: Aug. 4, 2022

(54) Method for assisting the use of an electronic transaction device.

(71) Applicant: BANKS AND ACQUIRERS INTERNATIONAL HOLDING, PARIS (FR)

(72) Inventors: Olivier Blanc, PONT DE L'ISERE (FR); André Carabelli, SAINT-PERAY (FR); Stéphane Pavageau, LA ROCHE DE GLUN (FR)

(21) Appl. No.: 17/618,712

(22) PCT Filed: Jun. 12, 2020
(86) PCT No.: PCT/EP2020/066386

§ 371 Date: Dec. 13, 2021

(30) Foreign Application Priority Data
Jun. 14, 2019 (FR) FR1906407

(51) Int. Cl. G06Q 20/32; G06Q 20/40

(52) U.S. Cl. CPC G06Q 20/3221; G06Q 20/4012

(57) ABSTRACT

A method for assisting the use of an electronic transaction device. The method includes activating an assisted mode, the activation of the assisted mode being triggered by a detection of a placement of a data entry assistance accessory on a touch screen of the electronic transaction device.

### TECHNICAL FIELD

This technique relates to the field of the use of electronic transaction devices such as electronic payment terminals or automatic teller machines or smartphones with payment or transaction functionalities.

More specifically, the present technique relates to assistance in using and entering data on such electronic transaction devices, referred to as payment terminals below, by people having a visual impairment, for example a partially sighted or blind person.

This technique applies in particular, but not exclusively, to the entry of confidential codes or personal identification codes (or PIN code) and/or to navigation on a payment terminal during a transaction, that is to say during a payment method, for people having visual impairments.

### PRIOR ART

Payment terminals are widely used for carrying out transactions in physical points of sale. Their use is relatively easy, for the merchant as well as for a majority of users.

A conventional payment method generally includes the display, on the screen of the payment terminal, the amount of the transaction (or of the withdrawal of money in the case of an automatic teller machine), a request to insert the payment card into the payment terminal (or placement of the payment card on the payment terminal in the case of a contactless payment method), a request to enter the confidential code of the user on the keyboard of the payment terminal then a request to withdraw the card from the payment terminal. Carrying out a transaction, using such a payment method, is therefore relatively easy.

A major drawback nevertheless arises for people having a visual impairment. The term visually impaired means a person which is partially sighted, blind or having blurred vision, for example. This drawback lies in the fact that, for all types of payment terminals, visually impaired people cannot ensure/verify that the amount indicated on the payment terminal display corresponds to the exact amount of their purchases. Thus, they can only count on the good faith of the merchant or on the assistance of a guide.

Furthermore, with the democratisation of payment terminals with touch screens designed to facilitate data entry by users, major difficulties have emerged for people having visual impairments.

Indeed, to perform an entry on a touch screen, a user must select one or more keys (each associated with an alphanumeric character) on a virtual keyboard displayed on the touch screen, using a finger or a stylus. The payment terminal therefore no longer has a physical keyboard to enter data.

However, for the visually impaired, entering data with a virtual keyboard has drawbacks, in particular due to the fact that unlike physical keyboards, virtual keyboards are displayed on a flat screen and therefore do not allow the visually impaired to find their way spatially on the virtual keys.

In addition, the position of the keys may be different from terminal to terminal, or even from one payment/transaction application to another, making typing for a blind person relatively difficult.

These drawbacks are particularly troublesome for payment terminals or automatic teller machines (ATMs) which have a touch screen since when a user uses their bank card to make a payment or to withdraw tickets, they must enter their PIN code to authenticate. However, it is not possible for a visually impaired person to enter their PIN code on a virtual keyboard displayed on a touch screen without outside help.

Moreover, with current payment terminals implementing, for example, a payment method as described above, it is difficult for a visually impaired person to know the progress of their transaction or even to recognise the key selected on the virtual keyboard.

There is therefore a need for solutions allowing to assist the completion of transactions on electronic transaction devices for people having visual impairments.

### SUMMARY OF THE INVENTION

The present technique allows to overcome at least some of the drawbacks raised by the prior art. The present technique indeed relates, according to a first aspect, to a method for assisting the use of an electronic transaction device.

According to the proposed technique, the method comprises a step of activating an assisted mode, the activation being triggered by a detection of the placement of a data entry assistance accessory on a touch screen of the electronic transaction device.

In this way, the fact of placing a data entry aid accessory automatically triggers the switching to an assisted mode, called blind mode, for the use of the electronic transaction device, without any further action by the user or the merchant: no need to press a button for example. From that moment, the visually impaired user is autonomous to complete the transaction, thanks to the method for assisting the use of the electronic transaction device (for example assistance in entering a confidential code or assistance in carrying out a contactless transaction).

The transaction device can be an electronic payment terminal, a smartphone comprising payment functionalities, or else an automatic teller machine (called an ATM).

The data entry assistance accessory corresponds, for example, to:
a grid with reliefs intended to materialise, for example, the keys of a keyboard for entering a confidential code, this grid being detected automatically as soon as it is placed on the touch screen;
a flap which folds over the touch screen and whose closure is detected for example via a magnet, this flap may have a grid provided with reliefs intended to materialise for example the keys of a keyboard for entering a confidential code

In addition, the method further comprises a step of providing at least one assistance in using said electronic transaction device, said step of providing at least one assistance comprising a sub-step of emitting an audio message and/or a sub-step of modifying the display of said touch screen.

In this way, the assisted mode offers audio assistance to visually impaired people in order to enable them to complete a transaction. Visual assistance can replace or supplement audio assistance. Audio assistance is preferred for visually impaired people qualified as blind, for example. Visual aid can be a sufficient aid, or supplement the audio aid, in particular for partially sighted people.

Furthermore, said sub-step of emitting an audio message comprises the audio emission of at least one of:
a voice announcement relating to the activation of said assisted mode;
a voice announcement of the amount of a transaction implemented by said electronic transaction device or a withdrawal of money implemented by said electronic transaction device;
a voice announcement stating a payment option (cash, credit, loyalty card), with an inherent choice;
a voice announcement requiring the insertion or placement of a payment card into or on said electronic transaction device;
a voice announcement requiring the entry of a confidential code;
a voice announcement relating to the validation or rejection of a transaction implemented by said electronic transaction device or a withdrawal of money implemented by said electronic transaction device;
a voice announcement and/or a tone relating to a data entry error;
a voice announcement and/or a tone relating to a data entry correction;
a tone relating to navigation within the menus of said electronic transaction device;
a tone relating to a key selected on said data entry assistance accessory;
a voice announcement requesting the withdrawal of said payment card;
a voice announcement relating to the deactivation of said assisted mode.

Thus, the assisted mode offers audio assistance that allows user guidance throughout the use of the electronic transaction device, and in particular during the transaction steps implemented by the electronic transaction device. The use of the electronic transaction device, and in particular the entry of confidential code type data, are facilitated.

According to another particular aspect, said display modification sub-step comprises the display, on at least part of said touch screen of said electronic transaction device, of at least one of:
a standardised virtual keyboard;
an element of particular shape and colour relating to a navigation key selected on said data entry assistance accessory;
an element of particular shape and colour relating to a validation, correction or cancellation key selected on said data entry assistance accessory;
an element of particular shape and colour relating to an acceptance or rejection of a transaction implemented by said electronic transaction device or a withdrawal of money implemented by said electronic transaction device.

Thus, the assisted mode offers visual assistance which allows the user to be guided throughout the use of the electronic transaction device, and in particular during the transaction steps implemented by the electronic transaction device. The use of the electronic transaction device is therefore facilitated.

In particular, a standardised virtual keyboard, particularly adapted for the visually impaired, is displayed on the screen of the payment terminal.

According to yet another particular aspect, said step of providing at least one assistance in using said electronic transaction device comprises a sub-step of determining a language of issue of a payment card inserted into or placed on said electronic transaction device and/or a sub-step of determining at least one available language of said electronic transaction device, and in that said sub-step of emitting an audio message takes account of at least one of said determined languages.

In this way, the assisted mode allows to determine, if possible, the language used by the user via the data of their payment card. If the user's language is available in the electronic transaction device, then the sub-step of emitting an audio message is performed according to the user's language.

If the user's language is not available in the electronic transaction device, then the language used for emitting audio messages is a language set by default in the electronic transaction device.

In another particular embodiment, the method further comprises a step of deactivating said assisted mode for the use of an electronic transaction device, triggered by the detection of the removal of said data entry assistance accessory.

In this way, the method proposes that the assisted mode is automatically deactivated, when the data entry assistance accessory is detected as removed from the electronic transaction device. In other words, no further action by the user or the merchant is necessary. For example, there is no need to press a button. When the removal of the entry assistance accessory is detected, the electronic transaction device switches to its normal operating mode.

According to another aspect, the proposed technique also relates to an electronic transaction device comprising means for implementing the method described above.

In a particular embodiment, the electronic transaction device comprises means for detecting the placement and/or removal of said data entry assistance accessory, said detection means being configured to trigger means for activating/deactivating an assisted mode for the use of said electronic transaction device.

In this way, the electronic transaction device comprises the technical means necessary for detecting the placement and/or removal of a data entry assistance accessory so as to automatically activate/deactivate the assisted mode.

In a particular embodiment, the electronic transaction device comprises means for emitting at least one audio message relating to a transaction implemented by said electronic transaction device or to a withdrawal of money implemented by said electronic transaction device and/or relating to an action by a user on said data entry assistance accessory, when said assisted mode is activated.

Thus, the electronic transaction device comprises the technical means necessary for the emission of audio messages allowing to assist the use of the electronic transaction device.

In a particular embodiment, the electronic transaction device comprises means for controlling said display screen, said detection means, said activation/deactivation means and said audio message emission means.

In this way, the electronic transaction device comprises control means, in the form of a processor for example, allowing to control the various means on-board the electronic transaction device in order to implement the method for assisting the use according to the proposed technique.

### FIGURES

Other features and advantages of the invention will emerge more clearly upon reading the following description of several preferred embodiments, given by way of simple illustrative and non-limiting examples, and the appended drawings, among which:

FIG. 1 illustrates the main step of a method for assisting the use of an electronic transaction device, in a particular embodiment of the proposed technique;

FIG. 2 illustrates the steps of the method for assisting the use of an electronic transaction device, in another particular embodiment of the proposed technique;

FIG. 3 illustrates the sub-steps of deactivating the assisted mode of the assistance method in the embodiment illustrated in FIG. 2;

FIG. 4 illustrates the sub-steps of providing assistance in using an electronic transaction device of the assistance method in the embodiment illustrated in FIG. 2;

FIG. 5 schematically shows the main components of an electronic transaction device (a payment terminal in this example) capable of implementing the method for assisting the use of an electronic transaction device according to the proposed technique, in a particular embodiment;

FIG. 6 shows an example of a data entry assistance accessory, according to a first embodiment;

FIG. 7 illustrates a first perspective of an example of a data entry assistance accessory, according to a second embodiment; and

FIG. 8 illustrates a second perspective of the data entry assistance accessory according to the embodiment of FIG. 7.

### DETAILED DESCRIPTION OF THE INVENTION

The general principle of the proposed technique is based on the implementation of an assisted mode, called “blind” mode, in an electronic transaction device so as to assist a person having a visual impairment to carry out a transaction. The term electronic transaction device (referred to as payment terminal below) is understood to mean: an electronic payment terminal, an automatic teller machine, a smartphone with payment or transaction functionalities or else an autonomous beverage or snack dispensing post, for example.

More specifically, the proposed technique provides for switching the payment terminal between a conventional operating mode, called “normal mode”, and an operating mode dedicated to visually impaired people, called “blind mode”.

Switching between normal mode and blind mode is caused/triggered by the detection of the presence/placement of a data entry assistance accessory on the payment terminal, this data entry assistance accessory being placed on the touch screen of the payment terminal by the merchant or the user themself.

Thus, the method according to the invention allows to reinforce the autonomy of a visually impaired user in their use of a payment terminal, thanks to the implementation of several combined assistance means:
on the one hand, a data entry assistance accessory allowing a visually impaired user to enter data on a touch screen with a virtual keyboard,
on the other hand, a specific mode of operation of the payment terminal itself, called blind mode or assisted mode, allowing the user to be guided during a transaction (or a withdrawal of money).

Blind mode is a mode of assistance in using a payment terminal offering audio and/or visual assistance, allowing to guide the user during the payment method. For example, the assistance comprises the emission of audio messages and/or a change of display of the screen aiming at indicating the amount of the transaction or the withdrawal of money, to request the insertion or placement of the payment card and the entry of a confidential code or at indicating the validation or the refusal of the payment, etc. In other words, the blind mode assists, in particular in an audio and/or visual manner, the visually impaired person in all the steps allowing them to complete a transaction or a withdrawal of money.

Although the general principle described above can be implemented for all types of payment terminals, it is particularly adapted for payment terminals having a touch screen displaying information relating to the transaction (a payment or withdrawal of money) as well as a virtual keyboard for entering the confidential code, in particular. Indeed, this type of payment terminal creates many difficulties of use for visually impaired people, as indicated above.

The present technique relates, according to a first aspect, to an original method for assisting the use of a payment terminal. This method more particularly aims at controlling the switching of the payment terminal between the normal operating mode and the blind operating mode during the placement and removal, on the touch screen, of a data entry assistance accessory for visually impaired people.

According to a second aspect, the present technique relates to an electronic transaction device adapted for implementing such a method.

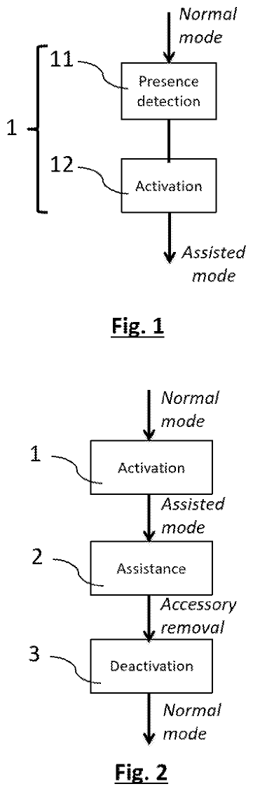

The various steps and sub-steps of the method according to the proposed technique are described below in relation to FIGS. 1 to 4. FIG. 5 moreover illustrates an example of an electronic transaction device allowing the implementation of the method of the proposed technique. More specifically, FIG. 5 illustrates an electronic transaction device in the form of a payment terminal.

The method for assisting the use of an electronic transaction device is described here in relation to an electronic payment terminal. It is obviously understood that such a method can also be implemented in an automatic teller machine or a smartphone having payment or transaction functionalities, in particular. The type of transaction described below corresponds to a payment (for a good or a service) by insertion of a payment card or in contactless mode but it can also be, as already indicated, a withdrawal of money in an automatic teller machine.

A payment method usually begins with displaying the transaction amount and requesting the insertion of a payment card. For this purpose, the payment terminal 9, illustrated in FIG. 5, comprises a screen 91 on which is displayed the amount of the transaction and a message requesting the insertion of a payment card.

The screen 91 of the payment terminal 9 also allows the display of other messages related to the payment method as well as the display of a virtual keyboard for entering a confidential code, in particular.

In a step 1 (FIG. 1), the payment terminal 9 activates an assisted mode for the use of the payment terminal 9, called blind mode, triggered by the detection of the presence of a data entry assistance accessory 8.

In other words, when a data entry assistance accessory 8 is placed on the screen 91 of the payment terminal 9, the latter switches from normal operating mode to blind operating mode.

For this purpose, the payment terminal 9 comprises means 92 for detecting the presence/placement or the absence/removal of a data entry assistance accessory 8. These detection means 92 are able to determine whether a data entry assistance accessory 8 is placed or not on the touch screen 91 of the payment terminal 9. These detection means 92 are linked/connected to activation/deactivation means 93 of the blind mode so as to activate or deactivate the blind mode according to the detection of the presence/absence of the accessory 8 on the payment terminal 9. In other words, the detection means 92 and the activation/deactivation means 93 act as switching control means between the normal mode and the blind mode of the payment terminal 9.

The detection means 92 are not detailed in the present patent application and can be implemented according to different techniques, such as for example that described in application FR 3 070 519 filed by the applicant.

The activation/deactivation means 93 of the blind mode are software means implemented in the control means 95 described below.

More specifically, step 1 for activating the assisted mode comprises sub-steps, so that when the presence of an accessory 8 is detected by the detection means 92 (sub-step 11), the detection means 92 send a presence signal to the activation/deactivation means 93 which trigger the activation of the blind mode (sub-step 12) on the payment terminal 9, that is to say they control the switching from the normal mode to the blind mode.

As illustrated in FIG. 2, the method for assisting the use of a payment terminal preferably comprises:
a step 2 (described in more detail below) of providing assistance in using the payment terminal on the payment terminal; and
a step 3 (described in more detail below) of deactivating the blind mode triggered by the detection of the absence/removal of a data entry assistance accessory 8 on the payment terminal 9.

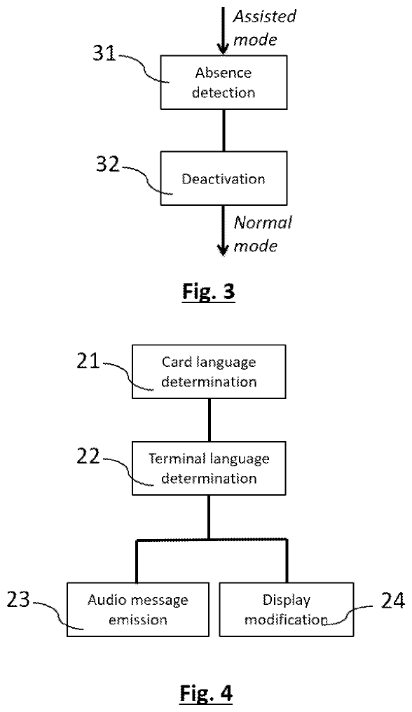

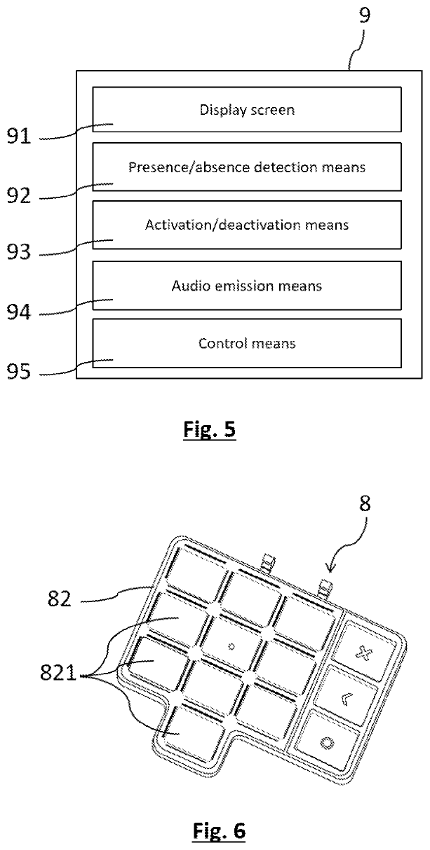

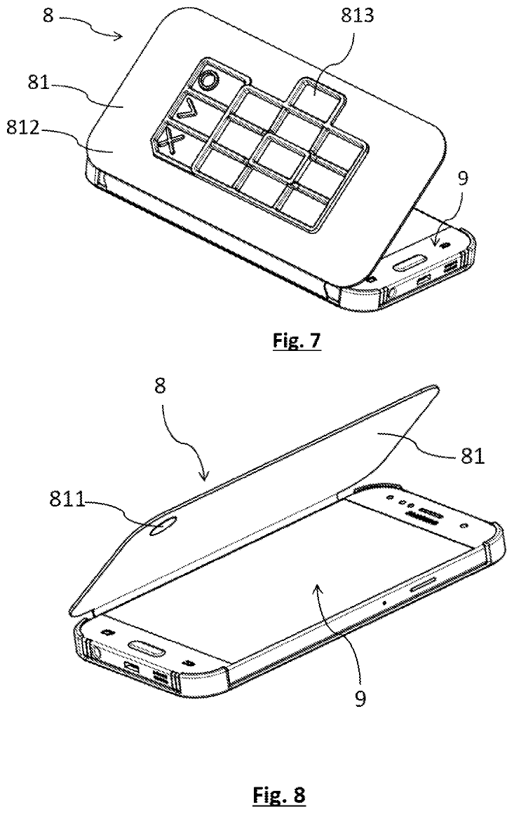

As illustrated in FIG. 3, it is the detection means 92 which, when the data entry assistance accessory 8 is removed from the payment terminal 9, detect this absence (sub-step 31) and send an absence signal to the activation/deactivation means 93 which will then trigger the deactivation of the blind mode (sub-step 32). In other words, the detection means 92 and the activation/deactivation means 93 also control the switching from the blind mode to the normal mode.

In a variant, switching from blind mode to normal mode could take place automatically, for example once the payment method is complete or when no key is selected by the user during a determined period (30 seconds, for example).

FIG. 4 illustrates the sub-steps of step 2 of providing assistance in using the payment terminal when the blind mode is activated. Step 2 of providing assistance in using the payment terminal can be implemented at each step of the payment method. For example, the step of providing assistance in using the payment terminal can be implemented when indicating the amount of the transaction, when requesting the insertion of the payment card, when entering the confidential code, etc.

Preferably, the step 2 of providing assistance in using the payment terminal comprises a sub-step 23 of emitting an audio message, by the payment terminal 9, aiming at assisting the user during the payment procedure. The audio message can consist of one of:
a voice announcement relating to the activation of the assisted mode;
a voice announcement of the amount of a transaction implemented by the electronic transaction device 9 or of a cash withdrawal implemented by the payment terminal 9;
a voice announcement stating a payment option (cash, credit, loyalty card), with an inherent choice;
a voice announcement requiring the insertion or placement of a payment card into or on the payment terminal 9;
a voice announcement requiring the entry of a confidential code;
a voice announcement relating to the validation or rejection of a transaction implemented by the electronic transaction device 9 or of a withdrawal of money implemented by the payment terminal 9;
a voice announcement and/or a tone relating to a data entry error;
a voice announcement and/or a tone relating to a data entry correction;
a tone relating to navigation within the menus of the payment terminal 9;
a tone relating to a key selected on the data entry assistance accessory 8;
a voice announcement requesting the withdrawal of the payment card;
a voice announcement relating to the deactivation of assisted mode.
etc.

These various audio messages are emitted depending on the progress of the payment procedure and are, if necessary, repeated according to a timer if no action is taken by the user. For example, if the user has not inserted their payment card within x seconds after the message asking them to do so, this message is repeated so that the user always knows what stage of the transaction they are at.

For this purpose, the payment terminal 9 comprises means 94 for emitting these audio messages. These emission means 94 are for example controlled by control means 95 (described below).

For example, the control means 95 is in the form of a processor allowing to control all the means 91 to 94 of the payment terminal 9. The control means 95 are also configured to implement the assistance method according to the proposed technique.

The transmission means 94 are, for example, in the form of a speaker or a jack if a headset or headphones are connected which, during the emission of audio messages, allow the user/visually impaired person to be guided and to know their progress in the payment method. The use of the payment terminal 9 is thus facilitated, so that a visually impaired person can carry out a transaction without the assistance of the merchant or an attendant.

Audio messages are pre-recorded or spoken with a voice simulator. These messages can also be synthesised from a text, in the user's language (if their card is inserted into the payment terminal and the language of the card detected) or from the payment terminal.

In addition to, or in substitution for, the sub-steps 23 of emitting an audio message, the step 2 of providing assistance in using the payment terminal comprises a sub-step 24 of modifying the touch screen display. Preferably, this sub-step 24 provides for the display, on all or part of the screen 91 of the payment terminal 9, of at least one element for assisting the use of the electronic payment terminal aiming at assisting the user during the payment procedure.

Depending on the progress of the payment method, the displayed element may consist of one of:
a standardised virtual keyboard;
an element of particular shape and colour relating to a navigation key selected on the data entry assistance accessory 8;
an element of particular shape and colour relating to a validation, correction or cancellation key selected on the data entry assistance accessory 8;
an element of particular shape and colour relating to an acceptance or rejection of a transaction or a withdrawal of money implemented by the payment terminal (9).

For example, the shape displayed on the screen 91 can be a green circle corresponding to the acceptance of a transaction, a red triangle corresponding to the refusal of a transaction, a black arrow on a white background (or vice versa) corresponding to a navigation key, etc.

Preferably, the display of this assistance element is performed on the entire screen 91, so as to facilitate the use of the payment terminal by a partially sighted person.

As indicated above, in the blind mode, a standardised virtual keyboard can be displayed on the screen of the payment terminal. This standardised keyboard, which is therefore common to all payment terminals, offers keys whose location is standardised and as large as possible, so that a visually impaired person can easily locate and therefore recognise and use the payment terminal more easily than in the normal mode.

Such a standardised keyboard provides a larger and simpler interface in order to facilitate its use by the visually impaired people.

Preferably, the standardised virtual keyboard is preferably displayed in landscape mode and adapts to the shape and dimensions of the screen of the payment terminal, which facilitates its use by a visually impaired person.

More preferably, the format of the standardised keyboard displayed on the screen 91 corresponds to the shape of the physical keyboard of the data entry assistance accessory 8 placed on the payment terminal 9.

In other words, the virtual keyboard is reformatted when switching to blind mode.

The screen 91 of the payment terminal 9, conventionally intended to display a virtual keyboard for entering data as well as conventional messages relating to the payment method, is also adapted for displaying such assistance elements. It should be noted that the display of a virtual keyboard can be deactivated in blind mode and replaced by a black screen in order to secure the transaction. Indeed, the display of such a virtual keyboard is useless for a visually impaired user and the replacement by a black screen allows to “disturb” any malicious observers who would try to know the digits entered to compose a confidential code without a visually impaired user realising it.

According to a particular aspect of the proposed technique, the step 2 of providing assistance in using the payment terminal comprises a sub-step of determining the language 21 of the payment card inserted into the payment terminal.

This sub-step 21 of determining the language of the card consists in collecting the information from the card and in identifying the language in which the card was issued by the supplier. Conventionally, the language of the card corresponds to the language of the user. More specifically, this information is contained in the software information of the card as “bearer language”.

Moreover, a sub-step 22 of determining the language(s) available in the payment terminal 9 is also implemented.

Thus, if the language of the card is available in the payment terminal 9, that is to say if the payment terminal is capable of displaying messages or of emitting audio messages in the language of the card, the sub-step of emitting an audio data entry assistance message 23 is carried out according to the language of the card.

Otherwise, that is to say in the case where the language of the card is not available in the payment terminal 9, the language used for the sub-step of emitting an audio message 23 is, by default, the language of the payment terminal 9 predefined in the latter, which corresponds for example to the language of the country wherein the payment terminal 9 is used.

This sub-step of determining the language(s) available in the payment terminal 9 allows in particular not to have to ask the user to select the language of use of the payment terminal and therefore not to take any action to be performed, for example by pressing a language selection button, prior to the transaction. Indeed, just as the display on the payment terminal of the amount of the transaction does not allow a visually impaired user to be autonomous to complete a transaction, the need to select a language of use, by pressing on a button after reading a message displayed on the screen of the payment terminal hinders the autonomy of a visually impaired user.

These sub-steps of determining the language of the card and of the payment terminal are implemented by the control means 95.

FIGS. 6 to 8 show two examples of data entry assistance accessories 8 allowing the implementation of the assistance method of the proposed technique.

According to a first embodiment illustrated in FIG. 6, the data entry assistance accessory 8 is in the shape of a grid 82 intended to be affixed randomly on a touch screen. The grid 82 has a matrix of keys 821 in relief allowing the entry of data by a visually impaired person, in particular. An example of such a grid 82 is described in application FR 3 070 519 filed by the applicant. For reasons of clarity, the grid 82 is therefore not described again in the present application. As indicated in application FR 3 070 519, the grid 82 is configured to be recognised by a touch screen regardless of its position and orientation on the screen so as to facilitate data entry by its user. Its use is therefore relatively easy and does not require any particular structural modification of the payment terminal.

The grid 82 can be used on any type of electronic transaction device provided with a touch screen for data entry. For example, such a grid 82 can be used on electronic payment terminals, automatic teller machines, autonomous fuel dispensing posts, or even on smartphones having payment or transaction functionalities.

Indeed, each of these devices comprises detection means 92 capable of detecting, for example, the presence of three contact points disposed under the grid 82.

A second embodiment of a data entry assistance accessory 8 is illustrated in FIGS. 7 and 8. The second embodiment of the data entry assistance accessory 8 is particularly adapted for a use with a smartphone with payment or transaction functionalities. For this purpose, the data entry assistance accessory 8 is in the form of a flap 81 which covers at least part of the screen 91 of the smartphone 9.

Flaps of this type are known in the field of accessories for mobile telephones, in particular. More specifically, it is known to use protective shells for mobile phones having a flap provided with a magnet 811, which can be opened to use the mobile phone. Conventionally, when the flap is folded down and covers the touch screen of the mobile phone, the mobile phone detects the magnet 811 and switches to standby mode in order to turn off the screen.

According to the proposed technique, the operation of the flap 81 is relatively close. Indeed, when the flap 81 is placed/folded down on the screen 91 of the smartphone 9, the magnet 811 is detected by the detection means 92 so as to trigger the switching from the normal mode to the blind mode.

More specifically, the detection means 92 of the smartphone comprise, in this example, a sensor for detecting a magnetic field (not illustrated) capable of detecting the presence of the magnet 811 of the flap 81 on the screen 91. For example, the sensor is in the form of a hall effect sensor, a magnetoresistive sensor, or a tunnel effect sensor (TMR).

So that the user can enter data, the flap 81 according to the proposed technique has, on the face 812 directed towards the user when the flap 81 is folded down on the screen 91, a grid 813 having a plurality of protruding keys. The grid 813 is configured so that a visually impaired person can orient themselves on the flap 81 and enter data, such as their confidential code in particular.

Preferably, the flap 81 is made of a translucent plastic material which does not prevent the use of the touch screen it covers.

In an alternative embodiment (not illustrated), the flap 81 implements a grid 82 as described above.

In this second embodiment, the detection means 92 implemented are different from those allowing the detection of an entry grid placed on the touch screen.

Thus, according to the present technique, the means 92 for detecting the presence/absence of the accessory 8 allow to detect any type of accessory, such as for example a flap or a grid described above.

The present technique therefore allows, according to the various embodiments described, to assist a visually impaired user of an electronic transaction device in the course of a transaction (payment or withdrawal of money for example), thanks to the triggering of a hearing or visual aid when the placement of a data entry aid accessory on the electronic transaction device is detected. The proposed technique therefore allows to reinforce the autonomy of such a user when carrying out a transaction via such a device, in complete security, in particular by the statement of the amount of the transaction which allows the user to have confidence.

1. A method for assisting use of an electronic transaction device, said method being performed by the electronic transaction device and comprising:
detecting placement of an accessory for assisting in entering data on a touch screen of said electronic transaction device;
activating an assisted mode, said activation being triggered by the detection of the placement of the accessory the touch screen;
providing at least one assistance in using said electronic transaction device, said providing at least one assistance comprising emitting an audio message and/or modifying a display of said touch screen, said emitting an audio message comprising audio emission of at least one of:
a voice announcement relating to the activation of said assisted mode;
a voice announcement of an amount of a transaction implemented by said electronic transaction device or a withdrawal of money implemented by said electronic transaction device;
a voice announcement stating a payment option;
a voice announcement requiring insertion or placement of a payment card into or on said electronic transaction device;
a voice announcement requiring entry of a confidential code;
a voice announcement relating to validation or rejection of a transaction implemented by said electronic transaction device or a withdrawal of money implemented by said electronic transaction device;
a voice announcement and/or a tone relating to a data entry error;
a voice announcement and/or a tone relating to a data entry correction;
a tone relating to navigation within menus of said electronic transaction device;
a tone relating to a key selected on said data entry assistance accessory;
a voice announcement requesting withdrawal of said payment card;
a voice announcement relating to deactivation of said assisted mode.

2. The method according to claim 1, wherein the providing at least one assistance comprises modifying the display of said touch screen, which comprises displaying, on at least part of said touch screen of said electronic transaction device, of at least one of:
a standardised virtual keyboard;
an element of particular shape and colour relating to a navigation key selected on said data entry assistance accessory;
an element of particular shape and colour relating to a validation, correction or cancellation key selected on said data entry assistance accessory;
an element of particular shape and colour relating to an acceptance or rejection of a transaction implemented by said electronic transaction device or a withdrawal of money implemented by said electronic transaction device.

3. The method according to claim 1, wherein the providing at least one assistance comprises emitting the audio message, which comprises determining a language of issue of a payment card inserted into or placed on said electronic transaction device and/or of determining at least one available language of said electronic transaction device, and said emitting the audio message takes account of at least one of said determined language.

4. The method according to claim 1, which further comprises detecting removal of said data entry assistance accessory and deactivating said assisted mode for the use of the electronic transaction device, triggered by the detection of the removal.

5. An electronic transaction device comprising:
a touch screen; and
a processor configured to:
activate an assisted mode, said activation being triggered by a detection of placement of the accessory the touch screen;
provide at least one assistance in using said electronic transaction device, said providing at least one assistance comprising emitting an audio message and/or modifying a display of said touch screen, said emitting an audio message comprising audio emission of at least one of:
a voice announcement relating to the activation of said assisted mode;
a voice announcement of an amount of a transaction implemented by said electronic transaction device or a withdrawal of money implemented by said electronic transaction device;
a voice announcement stating a payment option;
a voice announcement requiring insertion or placement of a payment card into or on said electronic transaction device;
a voice announcement requiring entry of a confidential code;
a voice announcement relating to validation or rejection of a transaction implemented by said electronic transaction device or a withdrawal of money implemented by said electronic transaction device;
a voice announcement and/or a tone relating to a data entry error;
a voice announcement and/or a tone relating to a data entry correction;
a tone relating to navigation within menus of said electronic transaction device;
a tone relating to a key selected on said data entry assistance accessory;
a voice announcement requesting withdrawal of said payment card;
a voice announcement relating to deactivation of said assisted mode.

6. The electronic transaction device according to claim 5, wherein the processor is configured to detect the placement and/or removal of said data entry assistance accessory and to trigger activating and deactivating the assisted mode for the use of said electronic transaction device.

7. The electronic transaction device according to claim 6, wherein the electronic device comprises at least one of a speaker and a jack, and wherein the processor is configured to emit through at least one of the speaker or the jack at least one audio message relating to a transaction implemented by said electronic transaction device or to a withdrawal of money implemented by said electronic transaction device and/or relating to an action by a user on said data entry assistance accessory, when said assisted mode is activated.

8. (canceled)
